(19) United States
(12) Patent Application Publication
(10) Pub. No.: US 2020/0320471 A1
(43) Pub. Date: Oct. 8, 2020

(54) EMETHOD AND APPARATUS FOR ITEM DELIVERY PREPARATION

(71) Applicant: Wal-Mart Apollo, LLC, Bentonville, AR (US)

(72) Inventors: Pratosh Deepak RAJKHOWA, Sunnyvale, CA (US); Shekhar GUPTA, Bangalore (IN); Pavan Kumar RAICHUR RAJOLI, Bangalore (IN)

(21) Appl. No.: 16/375,451

(22) Filed: Apr. 4, 2019

(51) Int. Cl. G06Q 10/08; G06Q 10/06; G06Q 50/30

(52) U.S. Cl. CPC G06Q 10/0832; G06Q 50/30; G06Q 10/06316; G06Q 10/08355

(57) ABSTRACT

This application relates to apparatus and methods for assigning items to containers that are placed on storage racks of delivery vehicles. In some examples, a computing device may obtain order data identifying at least one order for a plurality of items, and determine a specification, such as a weight or volume, of each item. The computing device may also obtain container data identifying container specifications such as container volume or holding weight. The computing device may assign a first item to a first container based at least partially on the specifications for the first item and the first container. The computing device may determine whether a second item may be assigned to the first container or a second container based at least partially on the specification of the second item, the specification of items already assigned to the first container, and the specification of the first container.

### TECHNICAL FIELD

The disclosure relates generally to delivery services and, more specifically, to delivery management systems.

### BACKGROUND

At least some retailers deliver purchased goods to a customer. When an order is placed, the retailers must gather the purchased goods and place them on a vehicle, such as a truck, for delivery. When a purchase order is received, the retailers may have associates that collect the goods for the purchase order from various areas of a warehouse or store. As the associates gather the purchased goods, they may place them into containers, such as totes. Typically, associates may gather the purchased goods based on where they are located in the warehouse or store. For example, the associate may leave a backroom with multiple containers, and proceed to the closest aisle to place any items purchased along that isle in a first container. The associate may proceed to the next closest isle or area of the warehouse, and proceed filing the first container with any items located there that were purchased.

Before filling a container with goods, the associate may have a label printed that identifies the container. For example, the associate may carry a label printer and print the label for the first container. The associate may also carry a scanner with which he scans the label so that the container may be registered in a delivery system. Once the first container is filled up with goods, assuming there are additional goods for the same order, the associate prints another label, places the label on a second container, and scans the label to register the second container. The associate then proceeds with filling the second container with additional items. The associate repeats this process until all purchased items are placed in a container. In addition, in at least some cases, an associate must also estimate a number of carrier bags required for the purchase order. The carrier bags are used to store specialty items, such as frozen items or meat items. The carrier bags are then placed into the containers after the specialty items have been stored in them. As the containers are filled, they may be stacked on a moving platform, such as a dolly or trolley. Once the associate is complete, the associate may proceed to take the containers on the moving platform to a part of the warehouse or store where the purchased goods may be placed into a delivery truck.

As such, an associate may spend a significant amount of time printing and scanning labels. Moreover, the associate may not know how many containers will be required for a given order. Thus, the associate often must guess at how many containers to bring along to collect the purchased goods. If the associate does not bring enough containers, the associate must walk back to the backroom to collect additional containers. On the other hand, if the associate brings along too many containers, the associate may have exhausted additional time and effort in bringing along the additional containers that in the end were not required. Therefore, for these and other reasons, retailers may benefit from reducing the amount of time it takes to collect items for delivery.

### SUMMARY

The embodiments described herein are directed to improving and/or optimizing delivery services by, for example, reducing the amount of time it takes to collect items for delivery. As a result, a retailer employing one or more of the embodiments may be benefit with less effort and time required for these and other activities, thereby allowing delivery personnel to become more efficient, improving customer service, and reducing delivery costs.

In some embodiments, a computing device is configured to obtain order data identifying at least one order for a plurality of items, and determine at least one specification for each item of the plurality of items of the at least one order. The computing device may also be configured to obtain container data identifying at least one specification for each container of a plurality of containers. The computing device may further be configured to assign a first item of the plurality of items to a first container of the plurality of containers based at least partially on the at least one specification for the first item and the at least one specification for the first container. In some examples, the computing device may further be configured to determine whether a second item of the plurality of items may be assigned to the first container based at least partially on the at least one specification of the second item, the at least one specification of the first item, and the at least one specification for the first container.

In some embodiments, a method is provided that includes obtaining order data identifying at least one order for a plurality of items, and determining at least one specification for each item of the plurality of items of the at least one order. The method may also include obtaining container data identifying at least one specification for each container of a plurality of containers. The method may further include assigning a first item of the plurality of items to a first container of the plurality of containers based at least partially on the at least one specification for the first item and the at least one specification for the first container. In some examples, the method may also include determining whether a second item of the plurality of items may be assigned to the first container based at least partially on the at least one specification of the second item, the at least one specification of the first item, and the at least one specification for the first container.

In yet other embodiments, a non-transitory computer readable medium has instructions stored thereon, where the instructions, when executed by at least one processor, cause a device to perform operations that include obtaining order data identifying at least one order for a plurality of items, and determining at least one specification for each item of the plurality of items of the at least one order. The operations may also include obtaining container data identifying at least one specification for each container of a plurality of containers. The operations may further include assigning a first item of the plurality of items to a first container of the plurality of containers based at least partially on the at least one specification for the first item and the at least one specification for the first container. In some examples, the operations may also include determining whether a second item of the plurality of items may be assigned to the first container based at least partially on the at least one specification of the second item, the at least one specification of the first item, and the at least one specification for the first container.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a delivery management system in accordance with some embodiments;

FIG. 2 is a block diagram of the delivery management computing device of FIG. 1 in accordance with some embodiments;

FIG. 3 is a block diagram of a container labelling system in accordance with some embodiments;

FIG. 4A illustrates a container in accordance with some embodiments;

FIG. 4B illustrates an example of a transport system for transporting containers in accordance with some embodiments;

FIG. 5 is a block diagram illustrating examples of various portions of the delivery management system of FIG. 1 in accordance with some embodiments;

FIG. 6 is a flowchart of an example method that can be carried out by the delivery management computing device of FIG. 1 in accordance with some embodiments; and

FIG. 7 is a flowchart of another example method that can be carried out by the delivery management computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

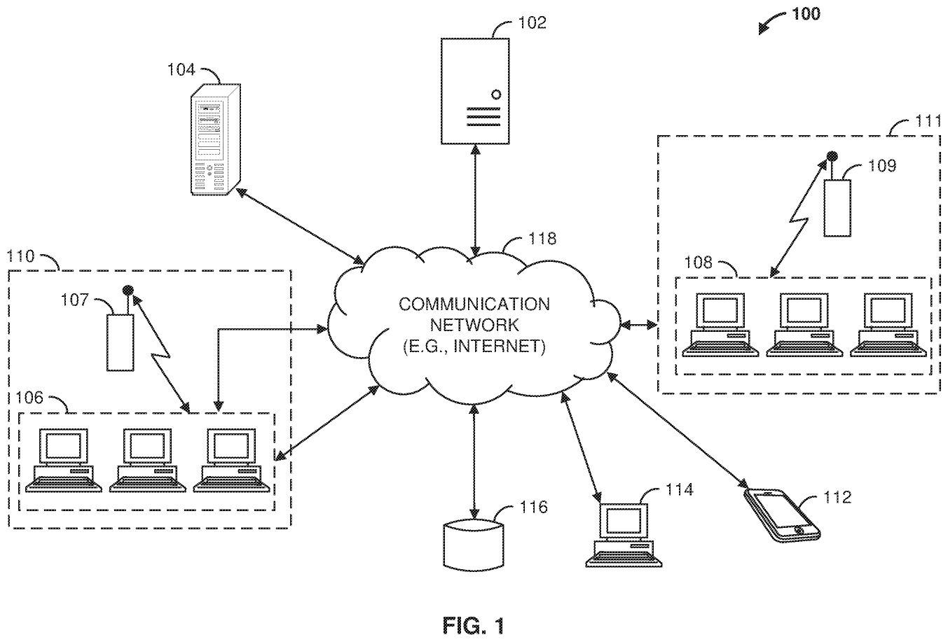

Turning to the drawings, FIG. 1 illustrates a block diagram of a delivery management system 100 that includes a delivery management computing device 102 (e.g., a server, such as an application server), a web hosting device 104 (e.g., a web server), workstation(s) 106, workstation(s) 108, database 116, and multiple customer computing devices 112, 114 operatively coupled over network 118. Delivery management system 100 may also include associate computing device 107 and associate computing device 109. Delivery management computing device 102, web hosting device 104, workstation(s) 106, workstation(s) 108, associate computing device 107, associate computing device 109, and multiple customer computing devices 112, 114 can each be any suitable computing device that includes any hardware or hardware and software combination for processing and handling information. In addition, each can transmit data to, and receive data from, communication network 118.

For example, each of delivery management computing device 102, web hosting device 104, workstations 106, workstations 108, associate computing device 107, associate computing device 109, and multiple customer computing devices 112, 114 can be a computer, a workstation, a laptop, a mobile device such as a cellular phone, a web server, an application server, a cloud-based server, or any other suitable device. Each can include, for example, one or more processors, one or more field-programmable gate arrays (FPGAs), one or more application-specific integrated circuits (ASICs), one or more state machines, digital circuitry, or any other suitable circuitry.

Although FIG. 1 illustrates two customer computing devices 112, 114, delivery management system 100 can include any number of customer computing devices 112, 114. Similarly, delivery management system 100 can include any number of workstation(s) 106, 108, associate computing devices 107, 109, delivery management computing devices 102, web hosting devices 104, and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Delivery management computing device 102, web hosting device 104, workstation(s) 106, 108, and associate computing devices 107, 109 may be operated by a retailer. Customer computing devices 112, 114 may be computing devices operated by customers of a retailer. For example, web hosting device 104 may host one or more web pages for the retailer. Each customer computing device 112, 114 may be operable to access the one or more webpages hosted by web hosting device 104 over communication network 118. For example, a customer operating a customer computing device 112, 114 may view a retailer's website hosted by web hosting device 104 as displayed by the customer computing device 112, 114, and may purchase products, such as goods or services, from the retailer's website by interacting with the website via the customer computing device 112, 114.

Workstation(s) 106, 108 may be operably coupled to communication network 118 via a router (or switch). As such, workstation(s) 106, 108 can communicate with delivery management computing device 102 over communication network 118. For example, workstations(s) 106, 108 may transmit data, such as purchase order data, to delivery management computing device 102. Similarly, workstation(s) 106, 108 may receive data from delivery management computing device 102. Workstation(s) 106, 108 may be located at a retail location 110, 111, such as a store. For example, workstation(s) 106 may be located at one store location 110 for a retailer, and workstation(s) 108 may be located at another store location 111 for that same, or different, retailer.

In some examples, workstation(s) 106, 108 may be located at a warehouse storing purchased goods, anywhere purchased goods may be located, or anywhere where purchased goods may be loaded onto a delivery vehicle, for example. Associate computing devices 107, 109 may be operated by associates of the retailer, and may be communicatively coupled to workstation(s) 106, 107, respectively. For example, workstation(s) 106, 108 may be located in a backroom of a store location, while associate computing devices 107, 109 may be operated by associates of the retailer as they walk around the store placing purchased items in containers.

Delivery management computing device 102 is operable to communicate with database 116 over communication network 118. For example, delivery management computing device 102 can store data to, and read data from, database 116. Database 116 may be a tangible, non-transitory memory. For example, database 116 may be a remote storage device, such as a cloud-based server, a memory device on another application server, a networked computer, or any other suitable remote storage. Although shown remote to delivery management computing device 102, in some examples, database 116 can be a local storage device, such as a hard drive, a non-volatile memory, or a USB stick. Database 116 may store purchase order data. For example, a customer may purchase good from a retailer's website hosted by web hosting device 104. Web hosting device 104 may store purchase order data identifying and characterizing the order in database 116. Delivery management computing device 102 may then obtain the purchase order data from database 116.

Delivery management computing device 102 may determine which items of a purchase order go into a container. The determination may be based on, for example, one or more of arrangement rules, item volume, item weight, container volume, and container holding weight. Delivery management computing device 102 may also determine a number of containers required for a purchase order. As described further below, each container may be identified by a container identification (ID) that, in some examples, may be printed on a label that is to be attached to the container. The labels may be placed on the containers before associates leave a backroom to begin placing items in each container.

In some examples, delivery management computing device 102 may compute a number of carrier bags required for each container. The carrier bags may be required to store specialty items, such as frozen items or meat items, or because customers have requested for all or part of their order to be placed into bags. In some examples, the number of carrier bags required would be printed on the container label. As such, this may allow retailer associates to place the required number of bags into each container, prior to an associate taking the containers onto a shop floor for filling the containers with purchased items (e.g., item picking). As such, the amount of time required for the selection and placement of items in containers (e.g., picking process) may be reduced.

In some examples, delivery management computing device 102 may determine that an item may not be placed into a carrier bag. For example, a large item that would not fit into a carrier bag may not be allowed to be placed into a carrier bag, and as such a carrier bag for that item would not be included. In addition, a carrier bag may have limits in terms of the volume and weight of items that can be placed into it. Delivery management computing device 102 may determine whether any of these conditions are violated, and assign items to the same, or different, carrier bags. In some examples, delivery management computing device 102 determines that certain items, such as uncooked meat, should be placed into a carrier bag (e.g., for safety or regulatory reasons), and thus assigns the item to a carrier bag.

In some examples, delivery management computing device 102 may assign items with more than one quantity (e.g., order lines with more than one quantity for a same item) across multiple containers. Delivery management computing device 102 may determine the volume and/or weight capacity of another container to accommodate the remainder of a split order line.

In some examples, delivery management computing device 102 may assign items to containers by their sequence number, which may be a location number assigned to each item. The sequence number may identify where in a store the item is located. Data associating items with sequence numbers may be input by an associate operating workstation(s) 106, 108, and may be stored in database 116, for example. Items with sequence numbers differing by a small amount may physically be closer to each other, as stored in the warehouse or store, than items with sequence numbers deferring by a larger amount. For example, delivery management computing device 102 may begin assigning items to a container starting from a lowest sequence number for a purchased item, and continuing with items with increasing sequence numbers, in order, as long as constraints for the container are not violated. The constraints may include, for example, volume, maximum load weight, and maximum items constraints, as described further below. For example, if a next item to be assigned has a larger volume than the available volume left in a current container, delivery management computing device 102 may assign that item to another container. As another example, if the next item to be assigned is heavier than the maximum weight allowed by the container (i.e., maximum load weight for the container), delivery management computing device 102 may assign that item to another container.

Although in some examples items with close sequence numbers indicates that the items are physically close to each other, that may not always be the case. For example, the sequence number assigned to an item may not correspond to the item's relative location to other items. To address these and other issues, in some examples, rather than the use of sequence numbers, delivery management computing device 102 may assign items to containers based on their location within a warehouse or store. For example, each item may have a location defined by a coordinate system (e.g., “X/Y” coordinate system). Delivery management computing device 102 may assign items that are closer to each other to a same container. For example, delivery management computing device 102 may assign a first item to a first container. Delivery management computing device 102 may then determine, based on the location data, the closest remaining item (e.g., out of the remaining items for an order) to the first item. Delivery management computing device 102 may then determine if that closest item can be assigned to the first container.

In some examples, delivery management computing device 102 determines an actual walking distance, rather than a line-of-sight distance, between items. For example, delivery management computing device 102 may determine, based on a mapping of the location where the items are stored, the distance between items based on a distance an associate would need to walk from one item location to another item location. In some examples, delivery management computing device 102 determines how many angled turns (e.g., “U” turns) are required to walk from the location of one item to other items to determine the distance between the items. Location data associating items with their location in a store may be input by an associate operating workstation(s) 106, 108, and may be stored in database 116, for example.

In some examples, delivery management computing device 102 applies a machine learning approach to assign items to containers. For example, delivery management computing device 102 may apply one or more machine learning processes, such as a decision-tree algorithm, to portions of data, such as historical item assignment data and solutions, to assign items to new containers.

In some examples, once delivery management computing device 102 begins to assign items to a next (e.g., new) container, any previous containers are no longer considered for item assignment. In some examples, delivery management computing device 102 “looks back” up to a maximum number of previous containers to determine if the item currently being assigned may be assigned to a previous container. For example, assume delivery management computing device 102 has assigned items to a first container, and is determining the assignment of another item. If the other item is larger than the volume left in the first container (e.g., after accounting for the volume of the items already assigned to the first container), delivery management computing device 102 may assign the other item to a second container. If yet another item is to be assigned to a container, delivery management computing device 102 may “look back” and first determine whether the item may be assigned to the first container. If the first container can hold the item, delivery management computing device 102 may assign the item to the first container. Otherwise, delivery management computing device 102 may determine whether the item may be assigned to the second container. In this example, the “look back” was one container. In some examples, the “look back” may include more than one container, such as three containers, for example.

The embodiments described herein may assist in minimizing the amount of walking an associate must undergo to collect all items for a purchase order. In addition, the time to locate and place items in containers for shipping or delivery may be reduced as well. The embodiments may offer a retailer additional benefits, such as cost reductions, delivery efficiency improvements, and customer satisfaction improvements. Other benefits may also be recognized by those skilled in the art.

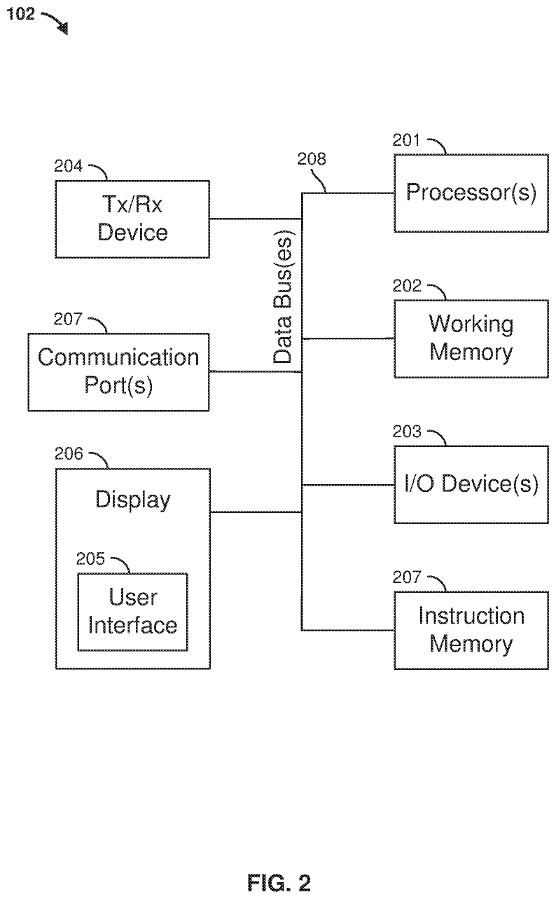

FIG. 2 illustrates the delivery management computing device 102 of FIG. 1. Delivery management computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of delivery management computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as item-to-container assignment data.

Display 206 can display user interface 205. User interfaces 205 can enable user interaction with delivery management computing device 102. For example, user interface 205 can be a user interface for an application that allows for the viewing of semantic representations of user queries. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 delivery management computing device 102 will be operating in. Processor(s) 201 is operable to receive data from, or send data to, a network, such as communication network 118 of FIG. 1, via transceiver 204.

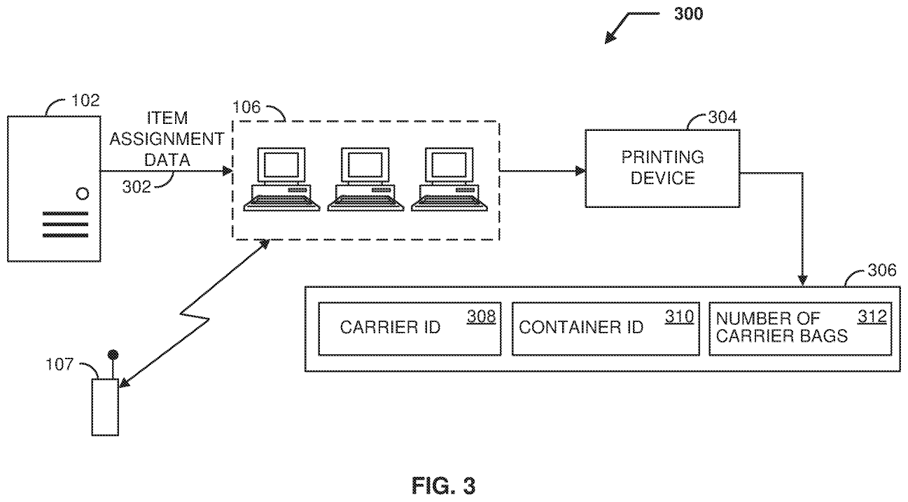

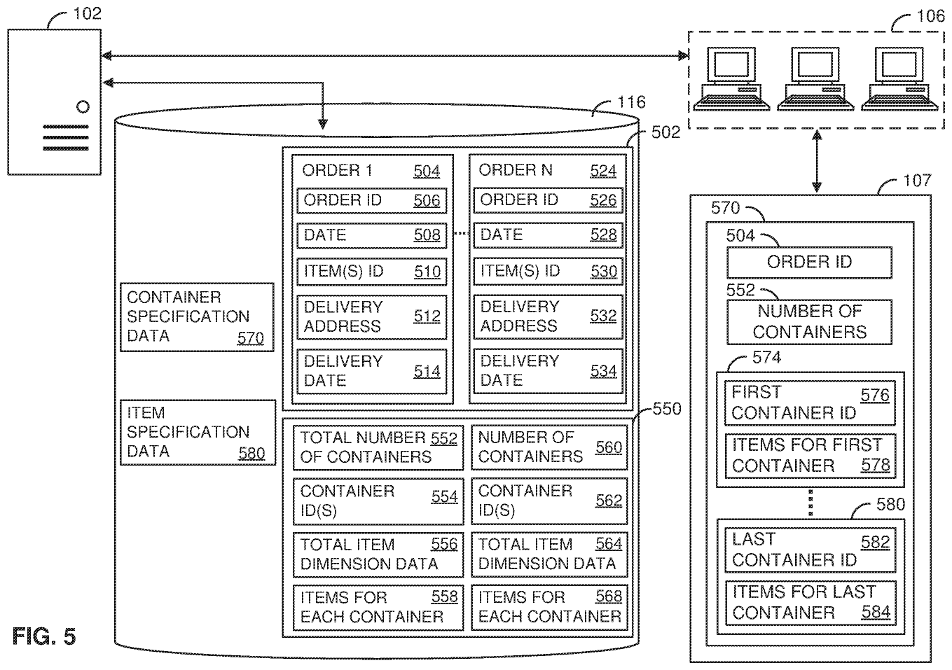

FIG. 3 illustrates a container labelling system 300 that includes delivery management computing device 102, workstation(s) 106, and a printing device 304. Printing device 304 may be a printer, a label maker, a labelling machine, or any other suitable printing device. Based on order information (e.g., as discussed in more detail with respect to FIG. 5 below), delivery management computing device 102 may determine container assignments for items of one or more orders. For example, delivery management computing device 102 may generate item assignment data 302 identifying container assignments for a plurality of items (e.g., a mapping of items to containers organized by container ID), and may transmit the generated item assignment data 302 to workstation(s) 106. Item assignment data 302 may also include, for example, a carrier ID, the container ID, and a number of carrier bags for each container of an order. The carrier ID may identify a delivery vehicle to deliver the container, whereas the container ID may identify the container itself.

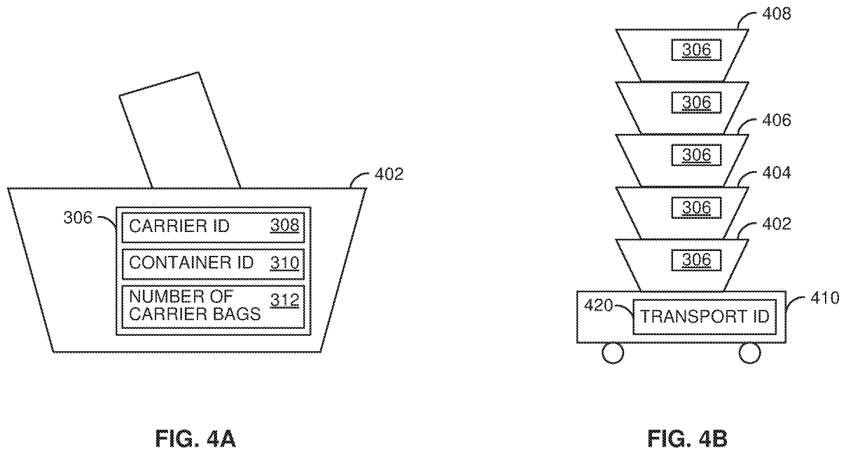

Workstation(s) 106 may receive the item assignment data 302, and format the item assignment data 302 to provide all or a portion of it to printing device 304 for label printing. For example, workstation(s) 106 may parse out and format item assignment data 302 to determine a carrier ID, a container ID, and number of carrier bags for one or more containers for an order. Workstation(s) 106 may then transmit the formatted data to printing device 304 for the printing of the received data on one or more labels. For example, workstation(s) 106 may send a “print” command to printing device 304, along with data identifying the item assignment data 302 to print on a label. Upon receiving the data, printing device 304 may print a label 306. Label 306 may include, for example, one or more of a carrier ID 308, a container ID 310, and a number of carrier bags 312. Label 306 may then be placed on a container, such as container 402 of FIG. 4A described below.

Workstations may also transmit the item assignment data to an associate computing device, such as associate computing device 107, as described below with respect to FIG. 5. An associate (e.g., a picker) may then fill a container with goods corresponding to item assignment data 302 received by associate computing device 107. For example, for a given order, an associate may proceed to a backroom and obtain a transport system (e.g., a dolly or trolley), such as the transport system 410 described below with respect to FIG. 4B, and place containers labelled with container IDs 308 for a particular order onto the transport system. The associate may then proceed to fill each container according to the item assignment data 302 received by associate computing device 107. For example, the associate may match container ID 308 on each container to a container ID received in the item assignment data 302, and proceed to fill each container with one or more goods associated with that container ID as identified in item assignment data 302.

FIG. 4A illustrates an example container 402. The container 402 is labelled with label 306. For example, label 306 includes identification of a carrier ID 308, a container ID 310, and a number of carrier bags 312. FIG. 4B illustrates a transport system 410 for transporting containers, such as container 402. Transport system 410 may be a dolly, or a trolley, for example. Transport system 410 may be labeled or otherwise marked with a transport identification (ID) 420. Transport ID 420 may identify a rack section of a storage rack of a delivery vehicle. For example, transport ID 420 may identify a “front,” “back,” or “middle” rack section of the storage rack. After containers are filled with corresponding goods, an associate may place the containers on transport system 410 for transport to, for example, a loading area for loading the container onto a delivery vehicle. The containers may then be placed in a storage rack of the delivery vehicle delivering the containers. In some examples, the containers are placed in the indicated rack section (e.g., as indicated by transport ID 420) of the storage rack of the delivery vehicle delivering the containers.

FIG. 5 illustrates portions of the delivery management system 100 of FIG. 1 including the delivery management computing device 102, workstation(s) 106, associate computing device 107, and database 116. As noted above, delivery management computing device 102 may determine item assignment data 302 for containers 402 used to deliver items. To determine item assignment data 302, delivery management computing device 102 may obtain order data 502 from database 116. Order data 502 may include order information, such as purchase order information (e.g., purchase order data), for one or more orders to be delivered. Order data 502 may be stored in database 116 by web hosting device 104, for example.

Order data 502 may include data identifying a plurality of orders, such as orders placed on a retailer's website. As illustrated, order data 502 may include data identifying a first order 504 up to a N^{th} order 524. First order 504 may include an order ID 506, which may identify the order. First order 504 may also include a date 508, which may be the date the order was placed, and one or more item IDs 510, where each item ID 510 identifies an ordered item. In some examples, item IDs 510 are sequence numbers. In some examples, the item IDs 510 are coordinate positions within a warehouse or store where the items are located. First order 504 may also include a delivery address 512 identifying the delivery address for first order 504, and a delivery date 514 identifying the date of delivery for first order 504. Similarly, N^{th} order 524 may include one or more of order ID 526, date 528, item(s) ID 530, delivery address 532, and delivery date 534.

Database 116 may also store container specification data 570, which may include data identifying one or more specifications for a container, such as container 402. For example, an associate may input container specification data 570 to delivery management computing device 102. Delivery management computing device 102 may then store container specification data 570 to database 116. Container specification data 570 may include, for example, a length, width, and height measurement for each of a plurality of containers. In some examples container specification data 570 may include a volume of each container, a maximum load weight that each container can or should be allowed to hold, and a maximum number of items that may be held by each container.

Database 116 may also store item specification data 580, which may identify one or more specifications of items, such as items in a retailer's inventory. For example, item specification data 580 may identify, for each item, one or more of a length, width, height, volume, and weight of an item. Item specification data 580 may also identify whether the item (e.g., a specialty item, such as an uncooked meat or frozen item) must be placed in a carrier bag, and whether the item must be placed alone (e.g., without any other items) in the carrier bag. Item specification data 580 may be stored in database 116 by, for example, delivery management computing device 102 in response to input from a retailer's associate. In some examples, item specification data 580 is a working database of specifications for each of a plurality of items that a retailer offers for sale.

Based on order data 502, delivery management computing device 102 may determine and generate item assignment data 550, and store item assignment data 550 in database 116. For example, referring to first order 504, delivery management computing device 102 may identify the items to be delivered for the order based on each of the item IDs 510. As noted above, in some examples, the item IDs 410 may be a sequence number of the item, or a coordinate position of the item. Delivery management computing device 102 may also obtain one or more specifications for the item from item specification data 580 based on the item ID 510 for the item. For example, delivery management computing device 102 may obtain a volume and a weight from database 116 for each item.

In some examples, delivery management computing device 102 obtains and sorts the items for a particular order, such as first order 504, according to a sequence number identified by their item ID 510. For example, beginning with the first (e.g., lowest) sequence number, delivery management computing device 102 generates data identifying the assignment of the item associated with the first sequence number to a first container. Delivery management computing device 102 may then determine if the item associated with the second sequence number can be assigned to the first container by determining whether one or more constraints would be violated. The constraints may include, among other examples: a volume of the container compared to a total volume of the items already assigned to the container; a maximum load weight of the container compared to a total weight of the items already assigned to the container; a maximum number of items that may be held by the container compared to the number of items already assigned to the container; or an item specification that the item should be stored in a carrier bag (e.g., a specialty item), and whether it must be stored in the carrier bag separately from other items. The constraints for one or more containers may be identified by, for example, container specification data 570.

For example, delivery management computing device 102 may obtain container specification data 570 to determine one or more constraints. As delivery management computing device 102 assigns an item to a container, delivery management computing device 102 may maintain a running total of a volume, weight, and/or a number of items that have been assigned to the container. Delivery management computing device 102 may determine, before assigning an item to a cart, if the addition of the item would cause a running total to be greater than a corresponding constraint of the container. For example, delivery computing device 102 may determine a potential item volume by adding a volume of a next item to assign to a container to a running total volume of items already assigned to the container. Delivery computing device 102 may compare the potential item volume to a volume of the container to determine if the potential item volume exceeds the volume of the container. If the potential item volume does not exceed the volume of the container, delivery computing device 102 assigns the next volume to the container. Otherwise, if the potential item volume does exceed the volume of the container, delivery computing device 102 does not assign the next item to the container. Instead, delivery computing device 102 may assign the next item to another (e.g., a next) container. Similarly, delivery management computing device 102 may also determine if one or more other constraints, such as the constraints stated above, would be violated by adding the next item to the container.

In some examples, delivery computing device 102 may need to separate quantities of the same item into separate containers based on constraints. For example, item IDs 510, 530 may identify an item, and a quantity for that item (e.g., five apples), such as an order line of a receipt. Delivery computing device 102 may determine a total weight or volume for the total quantity of that item, and attempt to assign the total quantity to a same container (e.g., delivery computing device 102 treats the total quantity for that item as one item). If one or more container restraints are violated, delivery computing device 102 may determine a minimum quantity of the total quantity of the items to satisfy the constraint being violated, and assign that portion of the quantity of items to the container. Delivery computing device 102 may then proceed to assign the remainder of the quantity of items to another container.

Delivery computing device 102 may proceed to assign all items from an order to one or more containers until all items have been assigned. Based on the assignments, delivery computing device 102 may determine order container data 550 for each order, and store contained data 450 in database 116. For example, delivery computing device 102 may determine a total number of containers required for the order, and store the total number of containers for the order in database 116. In this example, total number of containers 552 identifies the total number of containers required for first order 504, and total number of containers 560 identifies the total number of containers required for first order 504.

Delivery computing device 102 may also determine all of the container IDs for each container utilized for an order, and store the container IDs 554 for first order 504 and the container IDs 562 for N^{th} order 524 in database 116. Delivery computing device 102 may also generate and store in database 116 data identifying the items for each container 558 for first order 504 and f items for each container 568 for N^{th} order 524. Delivery computing device 102 may also generate and store total item dimension data 556 for first order 504 and total item dimension data 564 for N^{th} order 524 in database 116. Total item dimension data identifies one or more of the total number of items, total item volume, or total item weight per container for each order.

In some examples, delivery computing device 102 may transmit to workstation(s) 106, which may be located at a warehouse, store, or other storage facility where the items are stored, at least portions of order data 502 and order container data 550. For example, delivery computing device 102 may transmit, for each order, an order ID 506, 526, a number of containers 552, 560, container IDs 554, 562, and items for each container 558, 568. Workstation(s) 106 may then communicate some or all of the received information to one or more associate computing devices 107. Each associate computing device 107 may be operated by an associate who is to collect the items from the storage facility and place them into containers as specified by the received information.

For example, workstation(s) 106 may format and prepare for transmission to associate computing device 107 portions of order data 502 and order container data 550 received from delivery computing device 102. In some examples, workstation(s) 106 transmits to associate computing device 107, for each order, an order ID, a number of containers, container IDs, and items for each container. Associate computing device 107 may receive and display the information on display 570. For example, associate computing device 107 may display, for a given order, the order ID 504 and the number of containers 552 needed for the order. Associate computing device 107 may also display container data for each container needed for an order, such as first container data 574 up to N^{th} container data 580 for an order. First container data 574 may include a first container ID 576 of a first container of the order and items for the first container 578. Likewise, each container for the order may have corresponding container data displayed. For example, last container data 580 may include a last container ID 582 for a last container of the order and items for the last container 584.

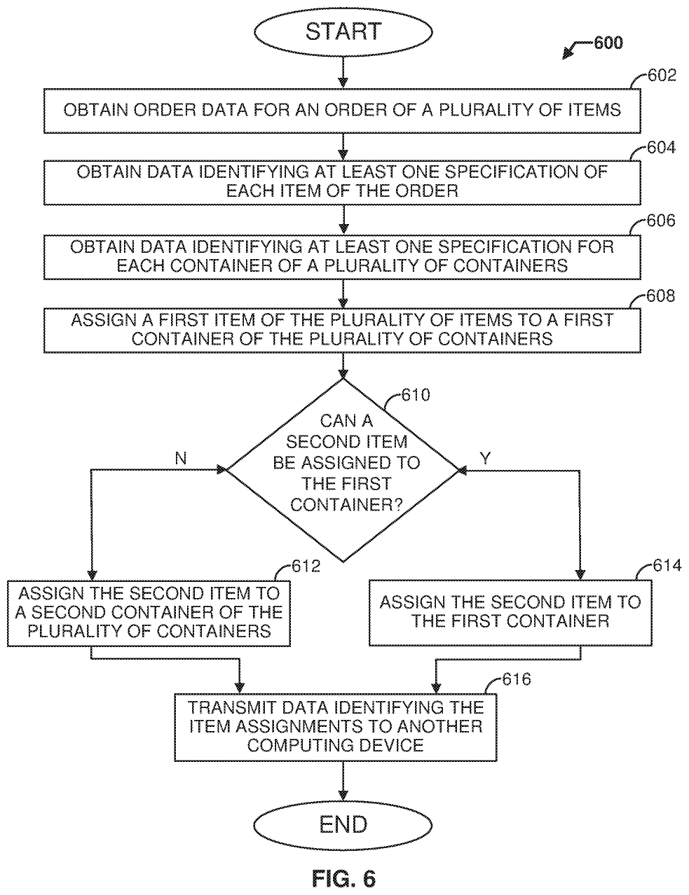

FIG. 6 is a flowchart of an example method 600 that can be carried out by, for example, the delivery management computing device 102 of FIG. 1. Beginning at step 602, order data, such data identifying first order data 504, is obtained for an order that includes a plurality of items. At step 604, data identifying at least one specification (e.g., property) of each item for the order is obtained. For example, the data may identify the volume or weight of each item. Proceeding to step 606, data identifying at least one specification for each container of a plurality of containers is obtained. For example, the data may identify a total volume of each container, or a maximum load weight of each container. At step 608, a first item of the plurality of items is assigned to a first container of the plurality of containers.

At step 610, determination is made as to whether a second item of the plurality of items may be assigned to the first container based on at least: one specification of the first item, one specification of the second item, and one specification of the first container. For example, the one specification of the first item may be a weight of the first item, the one specification of the second item may be the weight of the second item, and the one specification of the first container may be a holding weight of the first container. In this example, delivery management computing device 102 of FIG. 1 may determine if the holding weight of the first container can accommodate the weight of the second item in addition to the weight of the first item to determine whether the second item may be assigned to the first container.

If the second item may not be assigned to the first container, the method proceeds to step 612, where the second item is assigned to a second container of the plurality of containers. The method then proceeds to step 616. If at step 610, however, the second item can be assigned to the first container, the method proceeds to step 614, where the second item is assigned to the first container. The method then proceeds to step 616. At step 616, data identifying the assignment of the items is transmitted to another computing device, such as workstation(s) 106. The method then ends.

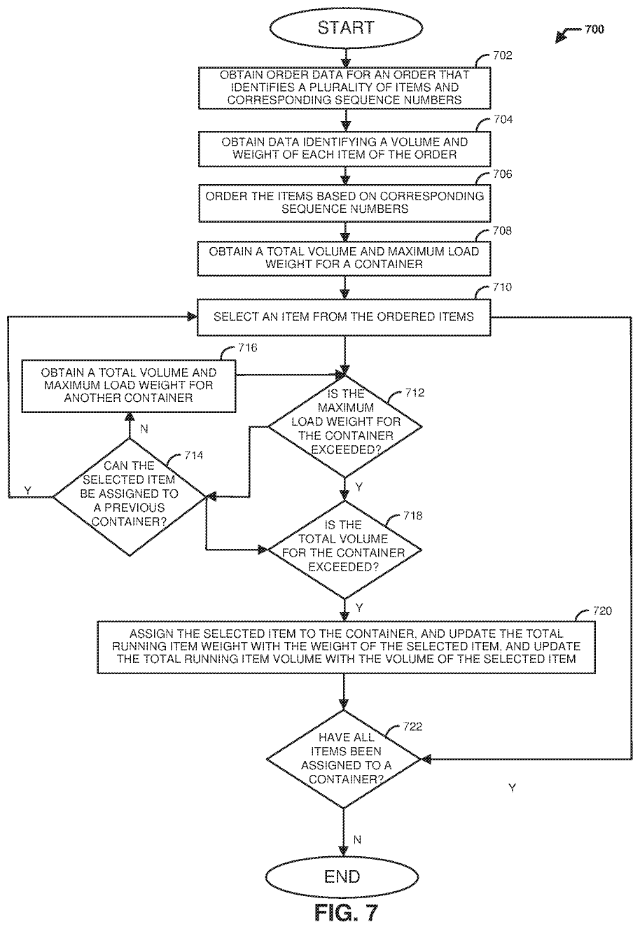

FIG. 7 is a flowchart of another example method 700 that can be carried out by, for example, the delivery management computing device 102 of FIG. 1. Beginning at step 702, order data, such data identifying first order data 504, is received for an order that includes a plurality of items. The order data identifies each item by a corresponding sequence number. At step 704, specification data including item volume and item weight is obtained for each item of the plurality of items of the order. At step 706, the plurality of items are placed in order by their sequence numbers. For example, a list is generated where the items are listed in order of their sequence numbers. In some examples, the items are placed in an order based on their proximity to each other (e.g., based on item coordinate data).

Proceeding to step 708, container data identifying at least a total volume and maximum load weight for a container is obtained. At step 710, an item from the ordered items, in order, is selected. For example, to begin, the first item from the order items is selected. The method then proceeds to step 712, where a determination is made as to whether a total running item weight and the weight of the selected item will exceed the maximum load weight of the container. For example, if the addition of the total running item weight (which may be 0 in a first iteration, assuming no items have yet been assigned to the container) and the item weight for the identified item do not exceed the maximum load weight of the container, the method proceeds to step 718. If, however, at step 712 the addition of the total running item weight and the item weight do exceed the maximum load weight of the container, the method proceeds to step 714.

At step 718, a determination is made as to whether a total running item volume and the volume of the identified item will exceed the total volume of the container. For example, if the addition of the total running item volume (which may be 0 in a first iteration, assuming no items have yet been assigned to the container) and the item volume for the identified item do not exceed the total volume of the container, the method proceeds to step 720. If, however, at step 718 the addition of the total running item volume and the item volume do exceed the total volume of the container, the method proceeds to step 714.

At step 720 the selected item is assigned to the container. In addition, the total running item weight is updated with the item weight for the selected item, and the total running item volume is updated with the item volume for the selected item. The method then proceeds to step 722, where a determination is made as to whether all items of the plurality of items have been assigned to a container. If all items have not yet been assigned, the method proceeds back to step 710, where another item from the ordered items, in order, is identified. If all items have been assigned, the method then ends.

As described above, the method may proceed to step 714 from either step 712, or step 718, depending on the outcome of those determinations. At step 714, a determination is made as to whether the selected item may be assigned to a previous container (e.g., “look back” and assign to a previous container). In some examples, the method may determine whether the identified item may be assigned an immediately preceding container. In some examples, the method may determine whether the identified item may be assigned to one of a previous number of containers, such as three containers. The determination of whether the identified item may be added to a previous container may include determining whether a total running item weight for that previous container and the weight of the identified item will exceed the maximum load weight of that previous container. The determination may also include determining whether a total running item volume for that previous container and the volume of the identified item will exceed the total volume of that previous container.

If the identified item may be assigned to a previous container, the method proceeds to step 710, where another item from the ordered items, in order, is identified. If the identified item cannot be assigned to a previous container, the method proceeds to step 716. At step 716, container data identifying at least a total volume and maximum load weight for a new container is obtained. The method will then use the new container for item assignments. From step 716, the method proceeds to step 712, where a determination is made as to whether a total running item weight and the weight of the identified item will exceed the maximum load weight of the new container.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain order data identifying at least one order for a plurality of items;
determine at least one specification for each item of the plurality of items of the at least one order;
obtain container data identifying at least one specification for each container of a plurality of containers;
assign a first item of the plurality of items to a first container of the plurality of containers based at least partially on the at least one specification for the first item and the at least one specification for the first container.

2. The system of claim 1, wherein the computing device is configured to:
determine whether a second item of the plurality of items may be assigned to the first container based at least partially on the at least one specification of the second item, the at least one specification of the first item, and the at least one specification for the first container.

3. The system of claim 2, wherein the computing device is configured to assign the second item of the plurality of items to the first container when a combination of the at least one specification of the first item and the at least one specification of the second item do not exceed the at least one specification for the first container.

4. The system of claim 3, wherein the computing device is configured to determine a current total item amount based on the at least one specification of the first item and the at least one specification of the second item when the second item is assigned to the first container.

5. The system of claim 4, wherein the computing device is configured to:
determine whether a third item of the plurality of items may be assigned to the first container based at least partially on the current total item amount, the at least one specification of the third item, and the at least one specification for the first container.

6. The system of claim 3, wherein the computing device is configured to:
determine that the combination of the at least one specification of the first item and the at least one specification of the second item does exceed the at least one specification for the first container; and
assign the second item of the plurality of items to a second container of the plurality of containers based on the determination.

7. The system of claim 6, wherein the second container is a container to which at least one item has previously been assigned, and wherein assigning the second item of the plurality of items to the second container comprises:
determining that a combination of a current total item amount for the second container and the at least one specification of the second item does not exceed the at least one specification for the second container.

8. The system of claim 2, wherein:
the at least one specification of the first item is based on a weight of the first item;
the at least one specification of the second item is based on a weight of the second item; and
the at least one specification for the first container is based on a maximum holding weight of the first container.

9. The system of claim 2, wherein:
the at least one specification of the first item is based on a volume of the first item;
the at least one specification of the second item is based on a volume of the second item; and
the at least one specification for the first container is based on a maximum volume of the first container.

10. The system of claim 1, wherein the order data identifies a sequence number for each item of the plurality of items, and wherein the computing device is configured to:
determine an order of the plurality of items based on their sequence numbers; and
determine a container assignment for each item of the plurality of items in the determined order.

11. The system of claim 10 wherein the sequence numbers for each item of the plurality of items identifies a coordinate of the corresponding item in a storage location, and wherein determining the order of the plurality of items comprises:
determining a closest item to the first item based on the coordinates corresponding to the plurality of items; and
determining that the closest item follows the first item in the determined order of the plurality of items.

12. The system of claim 1 wherein the computing device is configured to transmit to a mobile device data identifying assignments of the plurality items to the plurality of containers including the assignment of the first item to the first container.

13. A method comprising:
obtaining order data identifying at least one order for a plurality of items;
determining at least one specification for each item of the plurality of items of the at least one order;
obtaining container data identifying at least one specification for each container of a plurality of containers;
assigning a first item of the plurality of items to a first container of the plurality of containers based at least partially on the at least one specification for the first item and the at least one specification for the first container.

14. The method of claim 13 further comprising determining whether a second item of the plurality of items may be assigned to the first container based at least partially on the at least one specification of the second item, the at least one specification of the first item, and the at least one specification for the first container.

15. The method of claim 14 further comprising assigning the second item of the plurality of items to the first container when a combination of the at least one specification of the first item and the at least one specification of the second item do not exceed the at least one specification for the first container.

16. The method of claim 15 further comprising determining a current total item amount based on the at least one specification of the first item and the at least one specification of the second item when the second item is assigned to the first container.

17. The method of claim 16 further comprising determining whether a third item of the plurality of items may be assigned to the first container based at least partially on the current total item amount, the at least one specification of the third item, and the at least one specification for the first container.

18. A non-transitory computer readable medium having instructions stored thereon, wherein the instructions, when executed by at least one processor, cause a device to perform operations comprising:
obtaining order data identifying at least one order for a plurality of items;
determining at least one specification for each item of the plurality of items of the at least one order;
obtaining container data identifying at least one specification for each container of a plurality of containers;
assigning a first item of the plurality of items to a first container of the plurality of containers based at least partially on the at least one specification for the first item and the at least one specification for the first container.

19. The non-transitory computer readable medium of claim 18 further comprising instructions stored thereon that, when executed by at least one processor, further cause the device to perform operations comprising:
determining whether a second item of the plurality of items may be assigned to the first container based at least partially on the at least one specification of the second item, the at least one specification of the first item, and the at least one specification for the first container.

20. The non-transitory computer readable medium of claim 19 further comprising instructions stored thereon that, when executed by at least one processor, further cause the device to perform operations comprising:
assigning the second item of the plurality of items to the first container when a combination of the at least one specification of the first item and the at least one specification of the second item do not exceed the at least one specification for the first container.
